(19) United States
(12) Patent Application Publication
(10) Pub. No.: US 2014/0144860 A1
(43) Pub. Date: May 29, 2014

(54) TELESCOPIC TOWER CRANE SYSTEM

(71) Applicants: SEA ENERGY TECHNOLOGY CO., LTD., TAICHUNG CITY (TW); KUO PO HSUAN, TAICHUNG CITY (TW); KUO CHUNG HSUAN, TAICHUNG CITY (TW)

(72) Inventors: KUO FANG SHENG, TAICHUNG CITY (TW); KUO PO HSUAN, TAICHUNG CITY (TW); KUO CHUNG HSUAN, TAICHUNG CITY (TW)

(73) Assignees: KUO PO HSUAN, TAICHUNG CITY (TW); SEA ENERGY TECHNOLOGY CO., LTD., TAICHUNG CITY (TW); KUO CHUNG HSUAN, TAICHUNG CITY (TW)

(21) Appl. No.: 13/685,913

(22) Filed: Nov. 27, 2012

(51) Int. Cl. B66C 23/16

(52) U.S. Cl. CPC B66C 23/16
USPC 212/195

(57) ABSTRACT

A telescopic tower crane system has several tower layers of different outer diameters. Tower layers of smaller outer diameters are put inside the tower layers of larger outer diameters. Each of the tower layers consists of upstanding tower masts and crossbars connecting in between. The lower end of each of the tower masts has a lifting mechanism. Hoists are combined with the lifting mechanisms to lift the tower layers upward one by one from inside outward. The positioning mechanism at the lower end of each of the tower masts is positioned to the upper end of the adjacent tower mast. The crane tower is thus lifted to an extreme height and can lift heavy or long objects.

### BACKGROUND OF THE INVENTION

1. Field of Invention

The invention relates to a tower crane system and, in particular, to a tower crane system that stretches itself to elevate objects.

2. Related Art

Conventional engineering tower crane systems are divided into fixed one and self-elevating ones. The fixed tower crane system is restricted by its tower height and more difficult to lift large, heavy objects. The commonly seen self-elevating tower crane system is limited by the size of its node block as well as the counterweight configuration to be able to lift only weights between 1 to 30 tons. Suppose the lifted equipment is as heavy as an offshore wind turbine, whose weight is 200 to 400 tons for example, and is to be lifted to a height of about 80 to 110 meters. A normal tower crane system cannot handle such cases.

### SUMMARY OF THE INVENTION

An objective of the invention is to provide a telescopic crane system, which comprises multiple sets of tower layers consisting of vertical tower masts and crossbars from the outside to the inside. A hoist pulls up each of the tower layers from inside out to form a crane tower. It can be pulled up to a very high place. It also achieves the goal of lifting extremely heavy or extremely long objects.

To achieve the above-mentioned object, the disclosed telescopic crane system includes: a plurality of tower layers of different outer diameters, a plurality of lifting mechanisms, a plurality of positioning mechanisms, and a lifting arm.

Each tower layer is comprised of several vertical tower masts and crossbars connecting the tower masts that enclose a space of a distinct size. Tower layers of smaller outer diameters are put in order inside tower layers of larger outer diameters, forming a crane tower of sleeved tower layers. The outermost tower layer is called the outer tower layer, and the innermost tower layer is called the inner tower layer. Each of the lifting mechanism includes a coupling element that connects to the lower end of each of the tower masts. The lifting mechanism extends from the lower ends of the tower masts and connects with the hoist provided at each of the tower masts via a cable. The hoists pull the coupling element upward to lift all the tower layers except for the outer tower layer from inside outward.

Each of the positioning mechanism is disposed at the lower end of the corresponding tower mast of the tower layers except for the outer tower layer. Each of the positioning mechanism has a positioning pin extending from the interior of the corresponding tower mast. Except for the inner tower layer, the upper end of each of the tower masts of the tower layers is provided with a hole. After the tower layers are pilled up by the lifting mechanisms, the positioning pins can be inserted into the holes on the upper ends of the adjacent tower masts, thereby fixing their positions.

The lifting arm is provided at the top end of the inner tower layer. One end of the lifting arm has a hook, and the other end has a counterweight.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a planar view of the invention;

FIG. 2 is a top view of the invention;

FIG. 3 is a schematic view showing the action of the invention;

FIG. 4 is a locally enlarged view of part A in FIG. 3;

FIG. 5 is a locally enlarged view of part B in FIG. 4; and

FIG. 6 is a schematic view showing the invention after the crane tower is fully elevated.

### DETAILED DESCRIPTION OF THE INVENTION

The present invention will be apparent from the following detailed description, which proceeds with reference to the accompanying drawings, wherein the same references relate to the same elements.

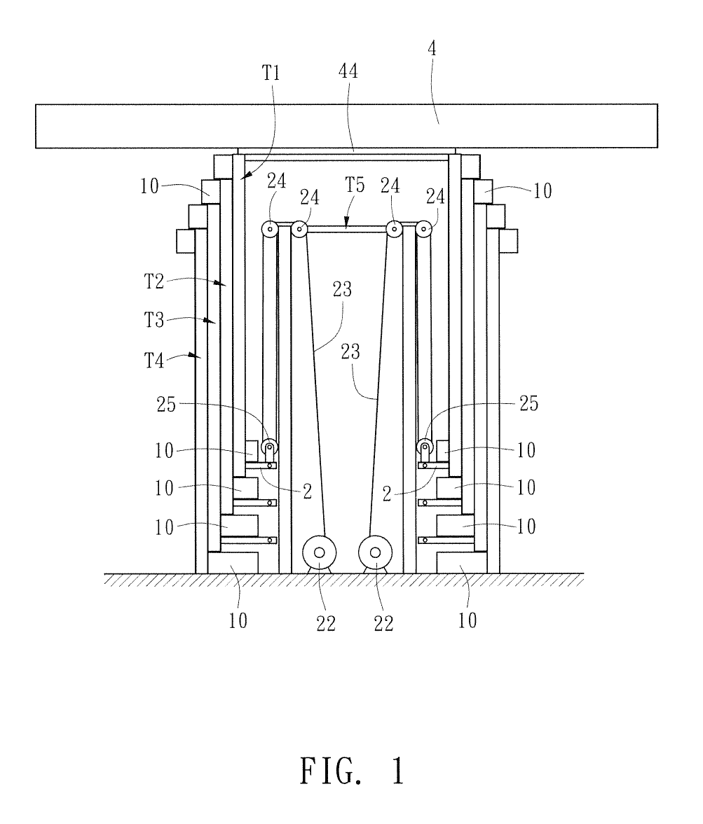

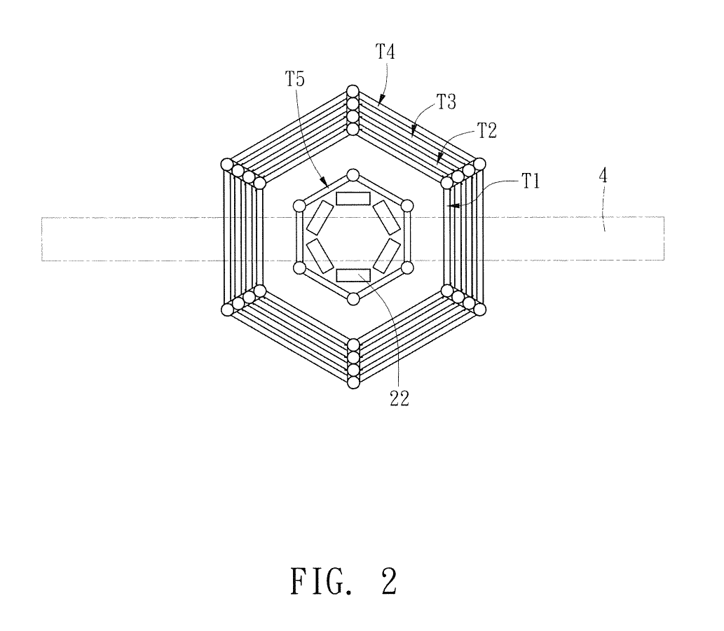

Please refer to FIGS. 1 and 2, which show the disclosed telescopic tower crane system. It has a number of tower layers T1˜T4 of different outer diameters. Each of the tower layers T1˜T4 consists of upstanding tower masts and crossbars connecting the tower masts that enclose a space of a distinct size. In this embodiment, each of the tower layers T1˜T4 has six tower masts at six corners, forming a hexagonal tower layer. The tower layers T1˜T4 are stacked in such a way that those with smaller outer diameters are put inside the space enclosed by those with larger outer diameters, forming a crane tower with sleeved tower layers. The outermost tower layer is defined as the outer tower layer T4, and the innermost tower layer is defined as the inner tower layer T1. The upper and lower ends of each of the tower layers T1˜T4 are provided with a box-shaped reinforcing beam 10, respectively.

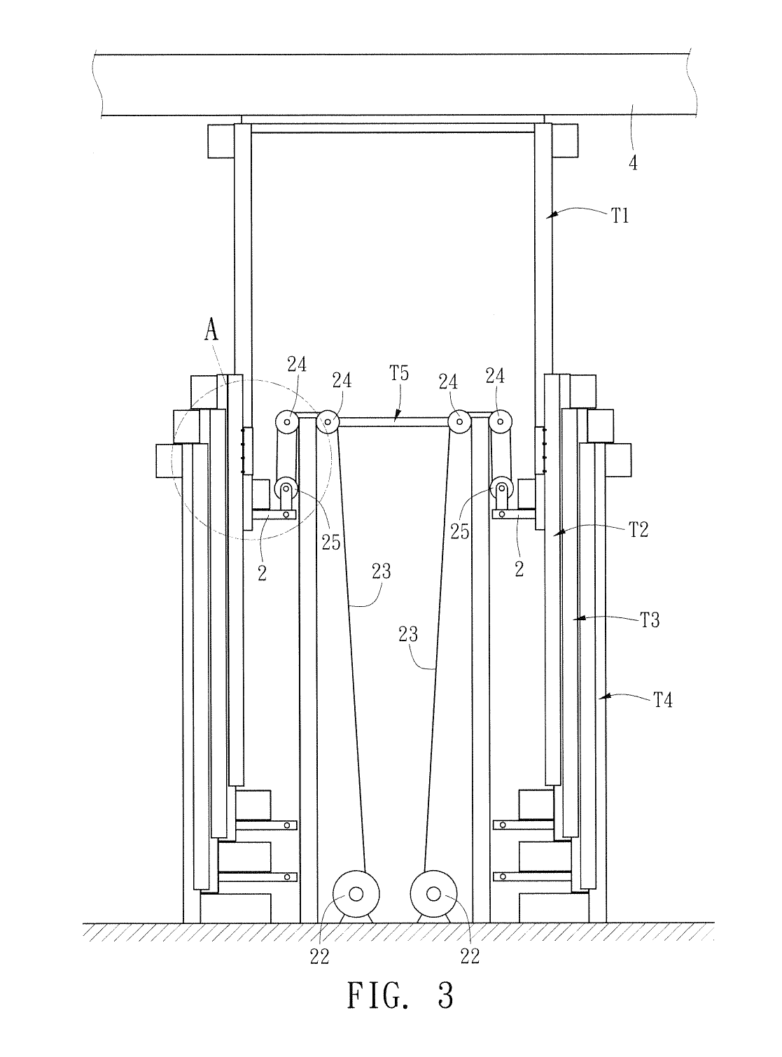

The invention has several lifting mechanisms, each of which includes a coupling element 2 provided on the lower end of each of the tower masts of the tower layers except for the outer tower layer T4. The coupling element 2 is driven by a hydraulic mechanism 21 to extend from the lower end of the tower mast to connect with a hoist 22 provided at the corresponding tower mast via a cable 23. Please refer to FIGS. 1, 3, and 4. More specifically, the lifting mechanism further comprises a central tower T5 located at the center of the crane tower. The central tower T5 has also six tower masts surrounding a hexagonal region. The outer diameter of the central tower T is smaller than the inner tower layer T1 and has a considerable height. Each of the hoists 22 is disposed on the ground inside the central tower T5. The top end of each of the tower masts of the central tower T5 is provided with a fixed pulley 24 for the tower masts of the corresponding tower layer. The cable 23 of each of the hoists 22 goes upward around the corresponding fixed pulley 24 and then downward to connect to a moving pulley 25. Each of the moving pulleys 25 is connected with the coupling element 2 extending from the bottom end of the corresponding tower mast of the inner tower layer T1. As the hoists 22 collect the cables 23, the coupling element 2 is pulled upward. As shown in FIG. 3, the inner tower layer T1 is lifted, thereby lifting some crane tower height. Afterwards, the moving pulleys 25 of the hoists 22 are connected to the coupling elements of the tower masts of the next tower layer. Therefore, except for the outer tower layer T4, the tower layers are lifted upward from inside outward.

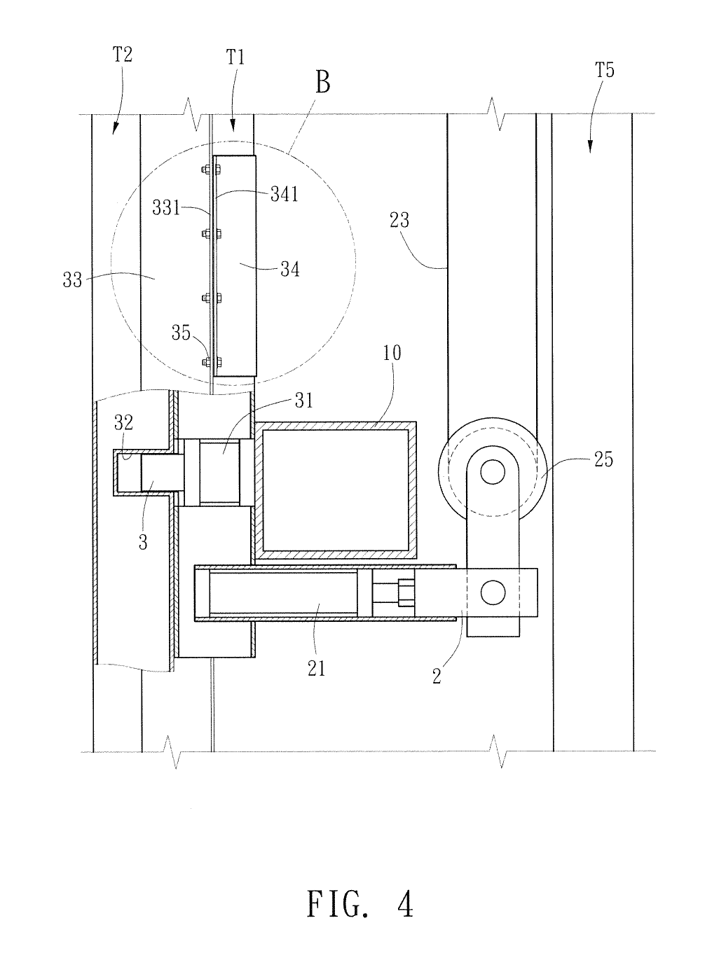

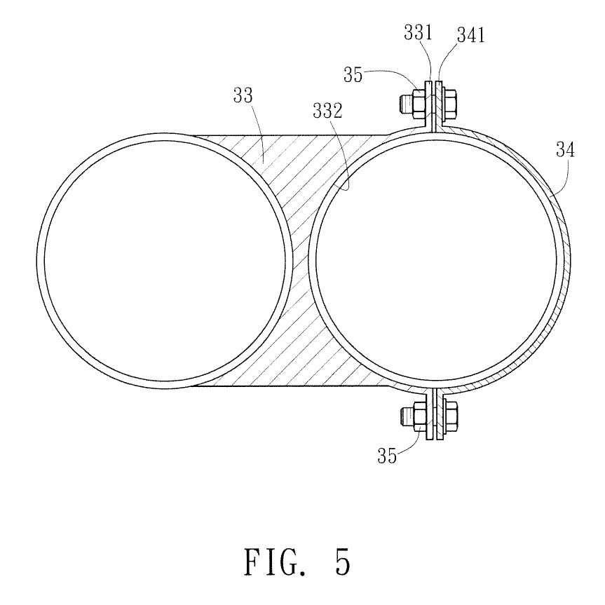

After the hoists 22 lift the tower layers, the positioning mechanisms are employed to fixed the lifted tower layer to the tower masts of the outer tower layer. As shown in FIG. 4, the positioning mechanism includes a positioning pin 3 provided on the lower end of each of the tower masts of each of the tower layers other than the outer tower layer T4. The positioning pin is driven by a hydraulic mechanism 31 extends horizontally from the interior of the tower mast. On the other hand, the upper end of each of the tower masts of each of the tower layer other than the inner tower layer T1 is formed with a hole 32 for the corresponding positioning pin 3. After each of the tower layers is lifted by the lifting mechanism, the positioning pin 3 is inserted into the corresponding hole 32, thereby fixing their positions. Furthermore, as shown in FIGS. 4 and 5, other than the inner tower layer TI, each of the tower masts of each of the tower layers is provided with a fixing part 33. The fixing part 33 is fixed to the tower masts on the outer side. Moreover, the fixing part 33 has a curved surface 332 facing the tower masts on the inner side. Both sides of the curved surface 332 are extended outward with wing parts 331 with a fixing hole, respectively. When the inner tower layer is pulled and lifted, the tower masts of the inner tower layer use the curved surface 332 of the fixing parts 33 as sliding grooves, providing a limiting effect. After the inner tower layer is lifted, a fixing element 34 fixes the lower end of the lifted tower mast to the fixing part 33. The fixing element 34 is a plate that also has wing parts 341 and fixing holes on both sides. Corresponding to the fixing part 33, a screw 35 is used to lock the fixing holes of the fixing part 33 and the fixed element 34, thereby reinforcing the positioning effect of two tower masts.

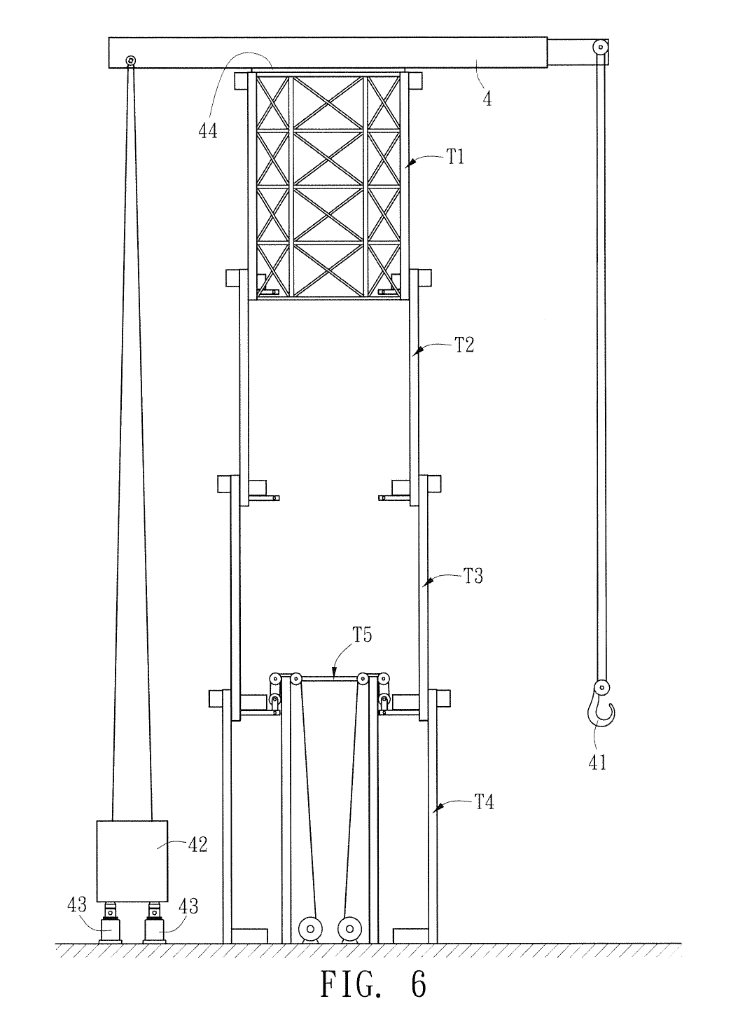

Through the above-mentioned lifting action, the crane tower is lifted upward layer by layer, finally reaching the form shown in FIG. 6. The top end of the inner tower layer T1 has a telescopic lifting arm 4, which is pivotally provided on the top end of the inner tower layer T1 via a turntable 44. The lifting arm can thus rotate 360 degrees. One end of the telescopic lifting arm 4 has a hook 41, and the other end has a counterweight 42. In this embodiment, the counterweight 42 is a water tank, in which water is loaded to adjust the counterweight. Besides, the counterweight 42 is hung from one end of the telescopic lifting arm to near the ground and is supported by a jack 43. When one starts to use this crane tower to lift and transport objects, the jack 43 is removed for the counterweight 42 to generate a balancing effect. The design of hanging the counterweight 42 to near the ground is to lower the overall center-of-gravity position of the crane tower. Therefore, when lifting objects, the rotational torque of the entire telescopic lifting arm 4 concentrates at the top end of the inner tower layer TI. This can effectively extend the lifetime of the disclosed tower crane system.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A telescopic tower crane system, comprising:
a plurality of tower layers of different outer diameters, each of which being formed by a plurality of upstanding tower masts and crossbars connecting between the tower masts to form a space of a distinct size, wherein the tower layers of smaller outer diameters are put in order inside tower layers of larger outer diameters, forming a crane tower of sleeved tower layers, with the outermost tower layer defined as the outer tower layer and the innermost tower layer as the inner tower layer;
a plurality of lifting mechanisms, each of which including a coupling element connecting to the lower end of the corresponding tower mast and extending from the lower end of the corresponding tower mast to connect to a hoist provided at the corresponding tower mast via a cable, wherein the hoist pulls the coupling element upward to pull the tower layers upwards layer by layer from inside outward except for the outer tower layer;
a positioning mechanism provided at the lower end of each of the tower masts of each of the tower layer other than the outer tower layer, having a positioning pin extending from the interior of the tower mast, wherein the top end of each of the tower masts of each of the tower layers other than the inner tower layer has a hole for the corresponding positioning pin to be inserted after each of the tower layers is lifted by the lifting mechanism; and
a lifting arm provided at the top end of the inner tower layer and having a hook on one end and a counterweight on the other end.

2. The telescopic tower crane system of claim 1, wherein the coupling element of the lifting mechanism and the positioning pin of the positioning mechanism are driven by a hydraulic mechanism to extend out of the tower mast.

3. The telescopic tower crane system of claim I further comprising a central tower at the center of the crane tower, wherein each of the hoists is disposed on the ground inside the central tower, the top end of the central tower is provided with a fixed pulley, the cable of each of the hoists goes upward around the corresponding fixed pulley and downward to connect to a moving pulley, and each of the moving pulleys connects to the coupling element extending from the lower end of the corresponding tower mast.

4. The telescopic tower crane system of claim 1, wherein the counterweight of the lifting arm is hung to near the ground and supported by a jack.

5. The telescopic tower crane system of claim 1, wherein the upper end and the lower end of each of the tower masts of each of the tower layers are respectively provided with a box-shaped reinforcing beam.

6. The telescopic tower crane system of claim 1, wherein a fixing part is provided on each of the tower masts of each of the tower layer other than the inner tower layer so that after the tower layers are lifted, a fixing element fixes the lower end of each of the tower masts to the fixing part.
